(19) United States
(12) Patent Application Publication
(10) Pub. No.: US 2024/0227078 A1
(43) Pub. Date: Jul. 11, 2024

(54) Integrated Precision Weldments

(71) Applicant: Textron Aviation Inc., Wichita, KS (US)

(72) Inventors: Royce Heick, Goddard, KS (US); Aaron Paul Shirley, Wichita, KS (US); Cameron Enderson, Havana, ND (US)

(21) Appl. No.: 18/405,035

(22) Filed: Jan. 5, 2024

Related U.S. Application Data
(60) Provisional application No. 63/478,655, filed on Jan. 5, 2023.

(51) Int. Cl. B23K 26/211; B23K 26/38; B23K 101/24; B23K 103/00

(52) U.S. Cl. CPC B23K 26/211; B23K 26/38; B23K 2101/24; B23K 2103/42

(57) ABSTRACT

A method of locating a stake to a floor assembly jig includes providing a floor assembly jig and a stake having a plurality of segments, laser cutting one or more slots into a structural member of the floor assembly jig, inserting at least one segment of the stake into the one or more slots thereby providing a substantially precise position and alignment of the stake with respect to the floor assembly jig, and securing the stake to the floor assembly jig to maintain the substantially precise position and alignment of the stake.

### CROSS-REFERENCE TO RELATED APPLICATIONS

This application claims the benefit of U.S. Provisional Application No. 63/478,655 entitled “Integrated Precision Weldments” and filed on Jan. 5, 2023, which is herein incorporated by reference in its entirety.

### BACKGROUND

### 1. Field

Embodiments of the invention relate generally to tooling, and more specifically the use of stakes located in laser cutting tubing for tool assembly.

### 2. Related Art

U.S. Pat. No. 10,634,008 to Richter discloses a method of manufacturing a housing of a turbomachine using laser beam cutting and welding. U.S. Pat. No. 6,419,146 to Buldhaupt et al. discloses a method and system for welding or diffusion-boding two metal sheets together using laser welding techniques. U.S. patent Application Publication No. 2016/0311062 to Tiwari et al. discloses a manufacturing method in which a composite part is placed on a support, scanned, and machined using a laser. U.S. Pat. No. 10,029,330 to Lowell et al. discloses a robotic system for integrated laser machining and metrology of a work piece. U.S. Pat. No. 4,859,826 to Hess III discloses a method of simultaneously cutting and welding metal. U.S. patent Application Publication No. 2020/0246912 to Diwinsky et al. discloses a system for automated laser ablation.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the invention will be apparent from the following detailed description of the embodiments and the accompanying drawing figures.

In an embodiment, a method of locating a stake to a floor assembly jig includes providing a floor assembly jig and a stake having a plurality of segments; laser cutting one or more slots into a structural member of the floor assembly jig; inserting at least one segment of the stake into the one or more slots thereby providing a substantially precise position and alignment of the stake with respect to the floor assembly jig; and securing the stake to the floor assembly jig to maintain the substantially precise position and alignment of the stake.

In another embodiment, a method of locating a stake to a floor assembly jig includes providing a floor assembly jig having at least one structural member; providing a stake having at least one segment; creating a substantially precise cut in the at least one structural member using a laser tube cutter; inserting the at least one segment of the stake into the substantially precise cut; and welding the stake to the at least one structural member.

In yet another embodiment, a method of forming a corner member includes providing first structural member and a second structural member; creating an angled end on each of the first and second structural members using a laser cutter; aligning the angled end of the first structural member with the angled end of the second structural member to form a corner having a substantially precise angle; and welding the angled end of the first structural member with the angled end of the second structural member to secure the substantially precise angle.

### BRIEF DESCRIPTION OF THE DRAWING FIGURES

Embodiments of the invention are described in detail below with reference to the attached drawing figures, wherein:

FIG. 1 depicts some embodiments of a floor assembly jig (FAJ);

FIG. 2 depicts some embodiments of a cross-sectional view of a stake inserted into a portion of the FAJ of FIG. 1;

FIG. 3 depicts some embodiments of a side perspective view of the stake inserted into a portion of the FAJ of FIG. 1;

FIG. 4A shows another embodiment of a FAJ;

FIG. 4B depicts a close-up view of the FAJ of FIG. 4A illustrating a corner connection;

FIG. 4C shows a cross-sectional view of the corner of the FAJ illustrated in FIG. 4B; and

FIG. 5 is a process-flow diagram illustrating a tooling method of some embodiments.

The drawing figures do not limit the invention to the specific embodiments disclosed and described herein. The drawings are not necessarily to scale, emphasis instead being placed upon clearly illustrating the principles of the invention.

### DETAILED DESCRIPTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized, and changes can be made without departing from the scope of the invention. The following detailed description is, therefore, not to be taken in a limiting sense. The scope of the invention is defined only by the appended claims, along with the full scope of the equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the technology can include a variety of combinations and/or integrations of the embodiments described herein.

Laser cutting is a process in which a material is cut using a high-power laser. In a typical laser-cutting setup, a laser is generated by some means, then focused by a lens before escaping through a nozzle on a laser-cutting device. Generally, the focused laser beam is less than a millimeter in diameter. The focused beam is directed onto a surface to be machined, and the beam is of such intensity that it vaporizes whatever portion of the material it is focused on. Laser cutting is preferable to mechanical cutting in that a laser, unlike a mechanical means of machining, experiences no wear, and a laser can provide extremely high precision that is difficult to obtain using mechanical cutting methods.

Manufacturing large structures designed to withstand substantial forces often requires very precise alignment and welding of components to withstand these forces safely and effectively. For example, the assembly of aircraft, spacecraft, submarines, boats, buses, trains, subways, and other vehicles often requires high precision tooling techniques to produce structurally sound components. For instance, in aircraft production, aircraft components may be assembled with a floor assembly jig, or FAJ, and in some cases welding or further assembly, of the aircraft components. Accordingly, FAJs are customized for the structural component being built. For example, using the aircraft production example, a specific FAJ may need to be built for certain sides of the fuselage. This FAJ is very specific to the fuselage of that particular aircraft. However, when updating that model aircraft or making any change within the fuselage production, a new FAJ must be produced to incorporate these changes. In certain cases, this involves the attachment of header boards with angles on the FAJs which hold components in place. Since the header boards are essential for proper alignment of the components, the header boards must be precisely placed, or adhered to, the FAJ (e.g., within 0.010-inch).

Currently, FAJs are assembled using manual operated hand tools to set, drill and thread holes, leaving significant potential for the misalignment of components. Furthermore, hand drilling these FAJs requires an extensive period of time to produce a satisfactory alignment between components used to assemble the FAJ. Accordingly, there is a need for a device, system, and method for performing swift precision alignment and assembly of components used in structural assemblies.

The present disclosure pertains to an FAJ assembled using a laser tube cutter. The use of such devices consistently produces a unique assembly with constituent components at specified alignments such that the FAJ is suitable for the mounting of structural components thereto. The present disclosure also pertains to the method of constructing such an FAJ using a laser tube cutter. The method of assembly minimizes the use of hand tools, thereby minimizing time required in aligning said tools and minimizing the potential of misalignment in the placement of a header board on an FAJ.

In embodiments, a laser cutter is used to produce cuts, such as apertures or slots, within a component. The sizes and shapes of these slots depends on how constituent parts of the completed FAJ are desired to fit together with one another. As an example, header boards of a specified shape and size must be placed at particular positions with particular alignments on the FAJ. Slots cut into a portion of the FAJ are of such a precise measurement that header board locator stakes may be fitted into said slots within 10,000ths of an inch on each side of the slot.

An item such as a locator stake may be placed into the appropriate slot or slots. The slim margin (i.e., 10,000ths of an inch) created between the item inserted and the slots for insertion means that a desired alignment and/or positioning can be achieved or nearly achieved by simply fitting the part into the slot, greatly facilitating assembly of the FAJ.

The item (e.g., stake) inserted to the slot is manually welded to the jig at the site of the insertion. The slot provides a quick and effective means for aligning the stake to the jig for welding.

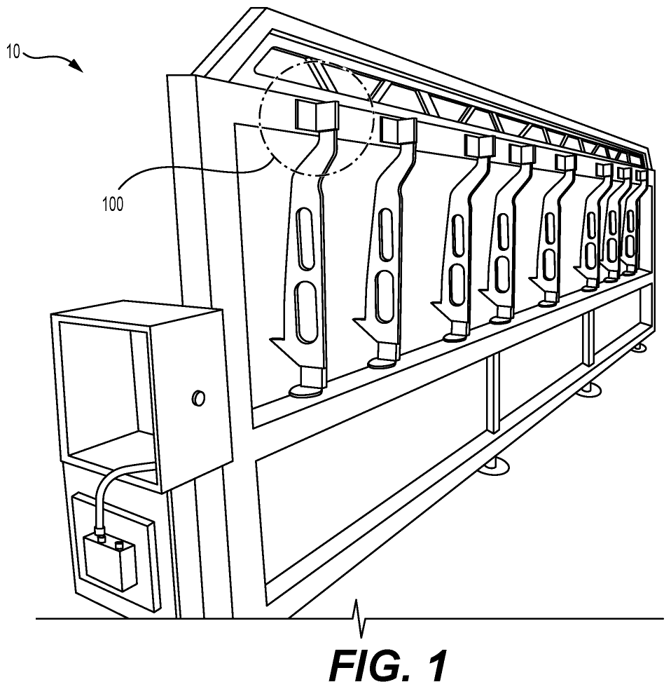

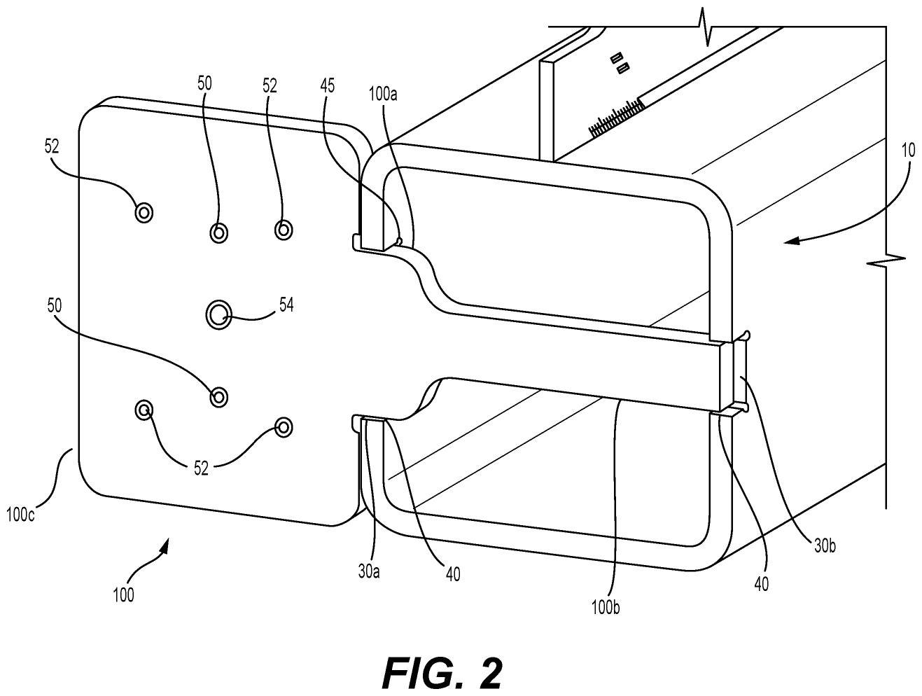

Referring now to FIG. 1, a jig 10 may serve as an FAJ to support components (not depicted) for tooling to produce a structural frame (e.g., a fuselage of an aircraft). These components may be temporarily mounted to jig 10 via a stake 100 for subsequent tooling. In some embodiments, stake 100 is mounted to jig 10 using laser weldments, with FIG. 2 providing specifics on the configuration of the mounting.

FIG. 2 illustrates stake 100 mounted on jig 10. Stake 100 is a single-piece item with holes 50 for mounting components for subsequent locating. Holes 50 may be hand-drilled or laser-cut into stake 100, and holes 50 may be threaded so that screws may be used in the mounting of components to stake 100. The FIG. 2 embodiment shows two holes 50 arranged in a predetermined pattern; however, stake 100 may include greater or fewer than two holes 50 of the same or differing diameters and in a variety of patterns without departing from the scope hereof. In addition to holes 50, stake 100 may include one or more threaded holes 52 which are configured to receive set screws, in some embodiments. The set screws may be used to aid in aligning a final locator into position combined with the use of laser tracking for alignment. A non-threaded hole 54 may be provided for receiving a dowel, in embodiments. The dowel may also be used for aligning components to stake 100 during assembly. The number and location of the threaded holes 52 and threaded hole 54 may be varied from what is shown in FIG. 2 without departing from the scope hereof.

In some embodiments, stake 100 may comprise a strong, stiff, and/or lightweight material, such as aluminum or aluminum alloy. However, it is contemplated that stake 100 may comprise any material necessary to support the components to be located. For example, the stake may comprise of steel, a metal alloy, a composite structure, plastic, etc. In embodiments, stake 100 comprises steel and is cut to size by using a water jet. Stake 100 may comprise a plurality of segments, such as stake segments 100a, 100b, and 100c shown in FIG. 2. The segments may be sized and shaped precisely (e.g., via water-jet cutting) such that their alignment to jig 10 is tightly controlled.

Stake segments 100a and 100b fit into slots 30a and 30b respectively, such that each segment of stake 100 is set into each hole within an extremely fine gap between each stake segment and its respective slot, such as 0.010-inch, or such that slots 30a and 30b are so restrictive that they hold stake segments 100a and 100b within 10,000ths of an inch of a desired position and alignment for positioning stake segment 100c within 10,000ths of an inch of a desired position and alignment. Slots 30a and 30b are holes that are cut into jig 10 using a laser cutter. Slots 30a and 30b may be of various shapes and sizes depending on the position and alignment of the stake with respect to the frame, for example. The use of a laser cutter in the cutting of slots 30a and 30b allows them to be cut such that there is an extremely fine distance between the edge of a cut slot and any specific component inserted therein, such that an extremely precise alignment of the inserted component relative to jig 10 is produced. Accordingly, precise placement of the stake 100 within jig 10 allows for subsequent precision of structural components to be attached to stake 100. Inner corners of the slots 30a and 30b may be removed to form recesses during the laser cutting process to assist with fitting of the stake segments 100a and 100b since corners of the stake segments 100a and 100b may be less precisely formed (e.g., via water-jet cutting) than the slots 30a and 30b via laser cutting. Exemplary recessed corners 45 are illustrated in FIGS. 2, 3, and 4C.

In some embodiments, welding (e.g., at weld locations 40 indicated in FIG. 2) integrate stake 100 into jig 10. Welds are produced such that the welding of stake 100 to jig 10 does not disrupt the alignment of stake 100 relative to jig 10. Mounting of stake 100 to jig 10 significantly reduces time and potential errors in the mounting process while also increasing precision of the mounting process. For example, prior art mounting processes typically use angles requiring about fourteen hand drilled holes in the steel jig along with ten hand threaded holes. Alternatively, stake mounting embodiments disclosed herein require only four hand drilled holes into a structural component attached to the stake (e.g., made of Aluminum or an Aluminum alloy) reducing the total number and difficulty of hand located, drilled, tapped and fastened locations.

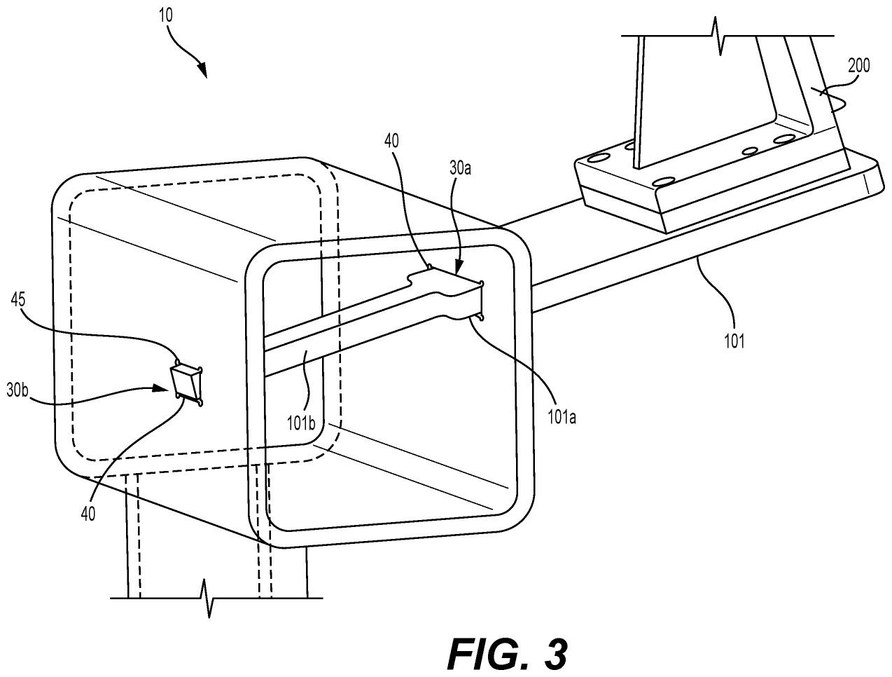

FIG. 3 illustrates embodiments a perspective view of structural component 200 mechanically attached to stake 100. In this instance, slots 30a and 30b are not parallel to any length of jig 10. Item 101 has segments 101a and 101b which fit into slots 30a and 30b respectively. Once the segments are fitted into the slots, each segment 101a and 101b is welded into its respective slot at weld locations 40.

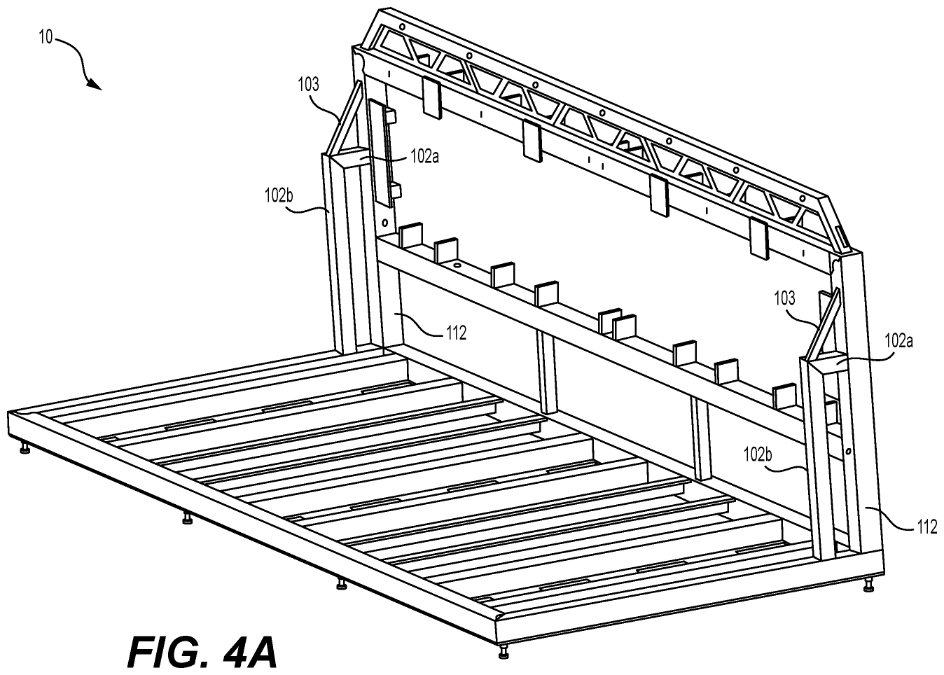

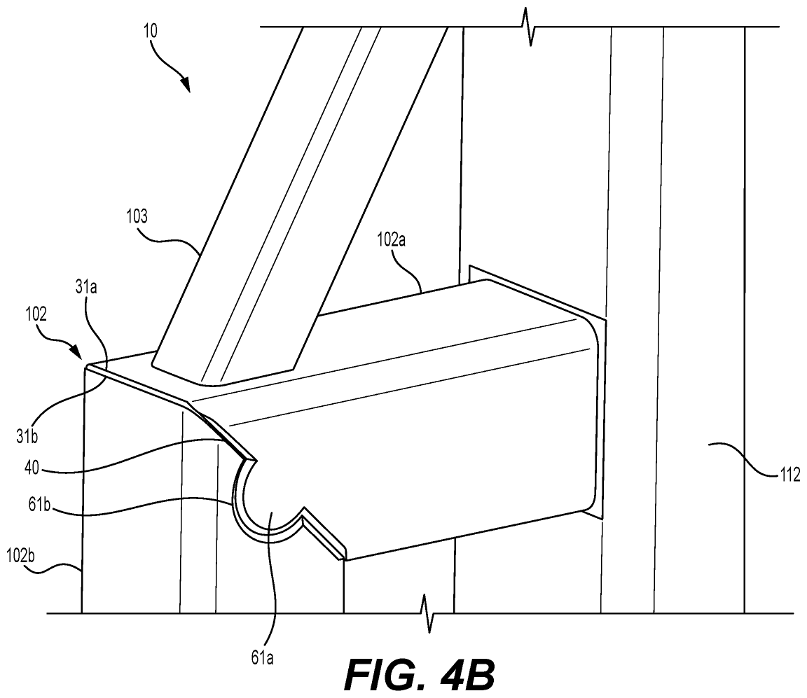

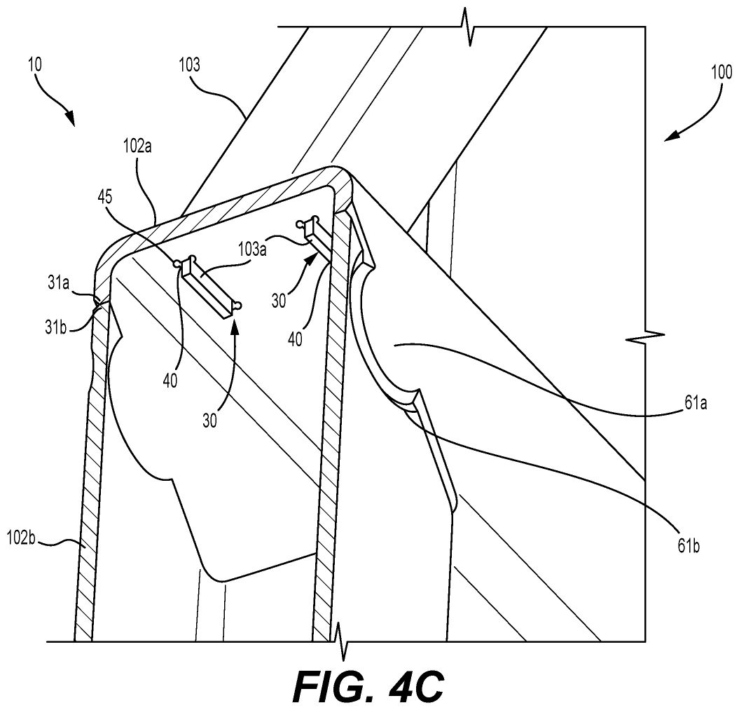

FIG. 4A shows another embodiment of jig 10. FIG. 4B shows a close up view of FIG. 4A illustrating a corner 102, and FIG. 4C shows a cross-sectional view adjacent the corner of FIG. 4B. FIGS. 4A, 4B, and 4C are best viewed together with the following description. Structural members 102a, 102b may be used to support or otherwise provide stability to jig 10. Structural member 102a is integrated into jig 10 at frame member 112, possibly being welded, glued, or otherwise attached to the frame member 112. Structural members 102a, 102b are arranged to form a corner 1002. A support member 103 is configured to provide additional support between structural member 102a and frame member 112, in embodiments.

In embodiments, structural members 102a and 102b have a square-shaped cross-section of some thickness with rounded vertices. A first end of structural member 102a is flat or otherwise shaped so that it may be integrated with jig 10 at frame member 112 (or otherwise mechanically coupled with jig 10 at frame member 112), and a second end of structural member 102a is cut at an angle (i.e., is not parallel with the first end of structural member 102a) such that a corner can be produced when structural member 102a is aligned and positioned with another angled piece. Structural member 102b is cut to form an angle configured to mate with the angled end of structural member 102a such that corner 102 is produced when structural member 102b is fitted with structural member 102a.

As best viewed in FIG. 4A, laser-cut edge 31a of structural member 102a comprises protruding portion 61a. Conversely, laser-cut edge 31b of structural member 102b comprises receiving portion 61b. Protruding portion 61a is configured to fit precisely into receiving portion 61b. Laser-cut edges 31a and 31b are cut with a laser cutter to such precision that no gap exists between structural members 102a and 102b when the laser-cut edges 31a and 31b are fitted to form corner 102. In embodiments, corner 102 is formed at a precise right angle (i.e., precisely 90-degrees) with a substantially small margin of error (e.g., +/−0.5-degree).

A weld is applied at one or more weld locations 40 to secure structural member 102a to structural member 102b, and ‘lock in’ the alignment of corner 102. For example, corner 102 may form a precise right angle with a substantially small margin of error in the measure of the angle.

FIG. 4B shows a cross-sectional view of corner 102. Support member 103 contacts structural member 102a and frame member 112 to provide further stability to corner 102. Structural member 102a has one or a plurality of laser-cut holes 30 to create slots in which one or a plurality of protrusions 103a on support member 103 may fit, and any laser-cut hole 30 may be attached to any protrusion 103a via welding (e.g., at one or more weld locations 40). Support member 103 is integrated with or attached to frame member 112 by welding, gluing, or other fastening means.

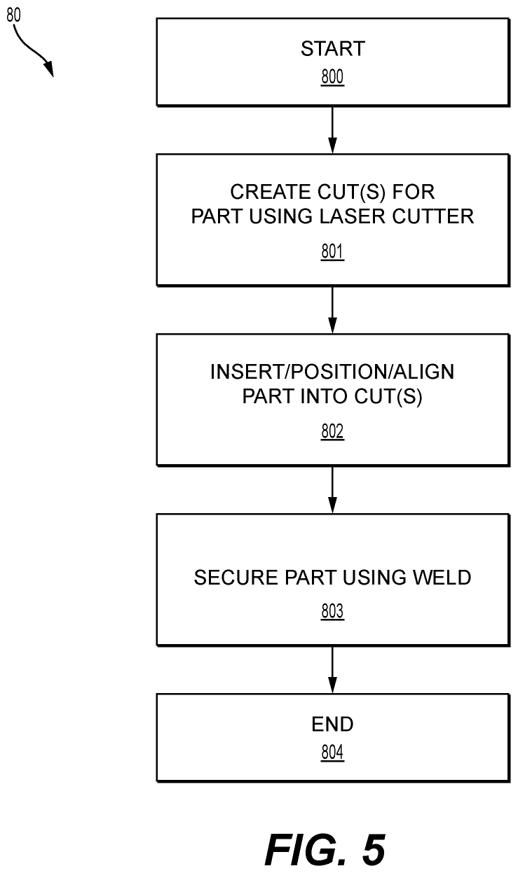

FIG. 5 illustrates an example method 80 of joining one part to another part using laser cutting techniques. An example of a set of parts that might be joined together is stake 100 on a frame member of jig 10.

After starting in step 800, a laser cutter is used to produce cuts within a component, such as slots, receiving portions, protruding portions, angled ends, etc., in a step 801. The sizes and shapes of the cuts depends on how two or more parts are intended to fit together upon assembly. As an example, stakes 100 of a specified shape and size may be desired at particular positions and alignments on an FAJ, such as jig 10. The cuts are substantially precise such that the stakes 100 are located on jig 10 in a desired substantially precise position and alignment without requiring subsequent adjustment. For example, the precision of the cuts are such that the gap between the inserted portion of the stake and the slot is about 0.010-inch. A joining material (e.g., a thermoplastic material) may be employed for securing each stake 100 to jig 10 (e.g., such that they may be welded together later in step 803).

The laser cutter, owing to its high precision, cuts out a slot in one part, such as slot 30a, configured for precise insertion of another part. The laser cutter may also cut additional slots for the insertion of any given part or parts, or it may cut out a shape at the edge of a part, such as edge 31a, and a shape at the edge of another part, such as edge 31b, such that those edges, when joined, fit the parts together to a desired substantially precise position and alignment (e.g., within 10,000ths of an inch of a desired position and alignment). This allows stake 100 to be located on jig 10 in the desired position and alignment without requiring subsequent adjustment.

Next, in step 802, the parts are contacted with one another in a desired position and alignment that is substantially precise. This could be as a part placed into the laser-cut insertion of another part, such as with stake segment 100a inserted into a frame member of jig 10, as seen in FIG. 2, or with multiple laser-cut parts placed together such that their laser-cut edges contact one another, such as with structural members 102a and 102b, as seen in FIGS. 4A and 4B. The slim gap (e.g., 0.010-inch) created between the item inserted and the slots enables a desired alignment and/or positioning between the parts (e.g., within 10,000ths of an inch) by simply fitting the part into the laser-cut slot or placing the laser-cut edges of the parts together without additional adjustment. This dramatically facilitates assembly.

In step 803, the two parts are secured together via welding for maintaining the desired position and alignment of the parts. The welds are produced such that the alignment of parts relative to one another is not disrupted. After the parts are secured together, the method ends in step 804.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by a Letters Patent includes the following:

1. A method of locating a stake to a floor assembly jig, comprising:
providing a floor assembly jig and a stake having a plurality of segments;
laser cutting one or more slots into a structural member of the floor assembly jig;
inserting at least one segment of the stake into the one or more slots thereby providing a substantially precise position and alignment of the stake with respect to the floor assembly jig; and
securing the stake to the floor assembly jig to maintain the substantially precise position and alignment of the stake.

2. The method of claim 1 wherein laser cutting one or more slots provides a gap of about 0.010-inch between each slot and a respective stake segment.

3. The method of claim 1 wherein inserting the at least one segment of the stake provides a desired position of the stake within 10,000ths of an inch.

4. The method of claim 1 wherein securing the stake to the floor assembly jig comprises welding the stake to the floor assembly jig without disrupting the substantially precise position and alignment of the stake.

5. The method of claim 1 wherein providing the stake comprises providing a single piece of material shaped with a plurality of segments, wherein the plurality of segments comprise at least one segment configured for insertion into the one or more slots.

6. The method of claim 5 wherein the stake comprises a plurality of holes configured for precisely mounting components to the stake.

7. The method of claim 6 comprising mounting a component to the stake via the plurality of holes.

8. The method of claim 7 wherein at least one of the plurality of holes is a threaded hole configured to receive a set screw, and adjusting a position of the component via the set screw.

9. The method of claim 7 wherein at least one of the plurality of holes is a non-threaded hole configured to receive a dowel, and adjusting alignment of the component via the dowel.

10. The method of claim 1 wherein laser cutting one or more slots comprises laser cutting recesses in inner corners of each of the one or more slots to form recessed corners.

11. The method of claim 1 further comprising laser cutting a protruding portion in an edge of a first structural member and laser cutting a receiving portion in an edge of a second structural member such that the protruding portion is received by the receiving portion when the edge of the first structural member is aligned with the edge of the second structural member.

12. A method of locating a stake to a floor assembly jig, comprising:
providing a floor assembly jig having at least one structural member;
providing a stake having at least one segment;
creating a substantially precise cut in the at least one structural member using a laser tube cutter;
inserting the at least one segment of the stake into the substantially precise cut; and
welding the stake to the at least one structural member.

13. The method of claim 12 wherein inserting the at least one segment of the stake into the substantially precise cut comprises positioning the at least one segment of the stake in a desired substantially precise position due to the substantially precise cut without requiring subsequent adjustment.

14. The method of claim 12 wherein inserting the at least one segment of the stake into the substantially precise cut comprises aligning the at least one segment of the stake in a desired substantially precise alignment due to the substantially precise cut without requiring subsequent adjustment.

15. The method of claim 12 wherein welding the stake to the at least one structural member comprises welding with thermoplastic material to secure the stake to the at least one structural member.

16. The method of claim 13 wherein welding the stake to the at least one structural member comprises maintaining the desired substantially precise position of the stake.

17. The method of claim 12 wherein creating the substantially precise cut provides a gap of about 0.010-inch between the at least one segment of the stake and the at least one structural member upon inserting the at least one segment of the stake into the substantially precise cut.

18. The method of claim 13 wherein positioning the at least one segment of the stake in a desired substantially precise position comprises positioning the stake to within 10,000ths of an inch of a desired position.

19. A method of forming a corner member, comprising:
providing first structural member and a second structural member;
creating an angled end on each of the first and second structural members using a laser cutter;
aligning the angled end of the first structural member with the angled end of the second structural member to form a corner having a substantially precise angle; and
welding the angled end of the first structural member with the angled end of the second structural member to secure the substantially precise angle.

20. The method of claim 19 comprising laser cutting a protruding portion in the angled end of the first structural member and laser cutting a receiving portion in the angled end of the second structural member, wherein aligning the angled end of the first structural member with the angled end of the second structural member to form a corner comprises inserting the protruding portion into the receiving portion.
